(19) United States
(12) Patent Application Publication
(10) Pub. No.: US 2003/0128551 A1
(43) Pub. Date: Jul. 10, 2003

(54) Tinge structure of a flexible light

(76) Inventor: Tzu-Chen Liu, Taipei (TW)

Correspondence Address: Tzu-Chen LIU, P.O. Box No. 6-57, Chung-Ho, Taipei, 235, TW

(21) Appl. No.: 10/041,477

(22) Filed: Jan. 10, 2002

(51) Int. Cl. F21V 7/04

(52) U.S. Cl. 362/551

(57) ABSTRACT

The present invention of a tinge structure for a flexible light mixes various fluorescent, silvering and phosphorescent agents or pearlescent and colorful pigments respectively into transparent polyvinyl chloride (PVC) plastic grains to be heated and pressed into a PVC pipe for a flexible light; or, various fluorescent, silvering and phosphorescent agents or pearlescent pigments are spread on the outer rim of a PVC pipe of the molded transparent flexible light thereby to make it have the colorful and gorgeous tinges not easy to fade so as to achieve more economic and practical efficiency.

### BACKGROUND OF THE INVENTION

1) Field of the Invention

The present invention relates to a tinge structure for a flexible light, more especially to a structure capable of making a polyvinyl chloride (PVC) pipe of the flexible light have the features of possessing colorful, gorgeous tinges and not being easy to fade so as to achieve more economic and practical efficiency.

2) Description of the Prior Art

Accordingly, after more than ten years of being available on the market, the style of a flexible light has been changed in a small scale and the tinges of the flexible light are still dominated by traditionally monochromic red, yellow, blue, green, purple and pink colors; that makes the entire flexible light look very boring with no variation; furthermore, the conventional PVC pipe looks very dull since the color thereof tends to fade after a long-term usage and that affects the visional presentation of the entire flexible light.

In view of the abovementioned shortcomings of the conventional flexible light, the inventor of the present invention, based on the spirit of innovation and searching for the best with the professional perspective and knowledge, developed the present invention of a tinge structure of a flexible light with more practicality and wider application scope to meet the value of industrial utilization.

### SUMMARY OF THE INVENTION

The present invention mainly mixes various fluorescent, silvering and phosphorescent agents or pearlescent and colorful pigments respectively into transparent polyvinyl chloride (PVC) plastic grains to be heated and pressed into a PVC pipe for a flexible light with fluorescent, silvering and phosphorescent agents or pearlescent and colorful pigments; or, various fluorescent, silvering and phosphorescent agents or pearlescent pigments are spread on the outer rim of a transparent PVC pipe of the molded flexible light.

The primary objective of the present invention is to mix or spread various fluorescent, silvering and phosphorescent agents or pearlescent and colorful pigments so as to change the traditional monochromic tinge of the entire flexible light for a colorful and gorgeous presentation thereby to strengthen the visional effect and eliminate the fading situation even after a long-term usage.

To enable a further understanding of the objectives, features and functions of the present invention, the brief description of the drawings below is followed by the detailed description of the preferred embodiment.

### BRIEF DESCRIPTION OF THE DRAWINGS

FIG. 1 is a schematic drawing of flexible light product of the present invention.

FIG. 1A is an enlarged view of area in FIG. 1.

FIG.2 is a drawing of the first exemplary embodiment of the present invention.

FIG.3 is a drawing of the second exemplary embodiment of the present invention.

FIG.4 is a drawing of the third exemplary embodiment of the present invention.

### DETAILED DESCRIPTION OF THE PREFERRED EMBODIMENTS

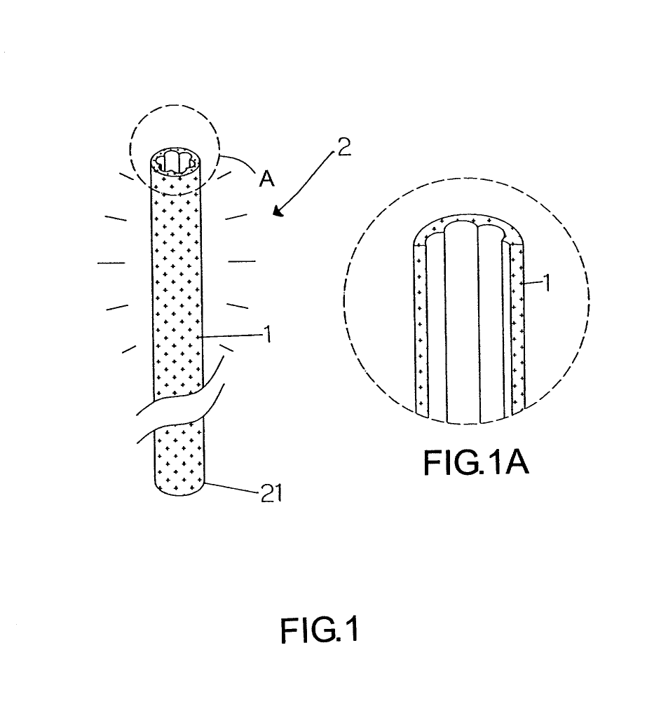

Referring to FIG. 1, the schematic drawing of flexible light product of the present invention, the present invention mainly makes the color inside the polyvinyl chloride (PVC) pipe of a flexible light colorful, gorgeous and not easy to fade; the features thereof are that various fluorescent (1), silvering and phosphorescent agents or pearlescent and colorful pigments are respectively mixed into transparent PVC plastic grains to be heated and pressed into a PVC pipe (21) for a molded flexible light (2) with fluorescent (1), silvering and phosphorescent agents or pearlescent pigments.

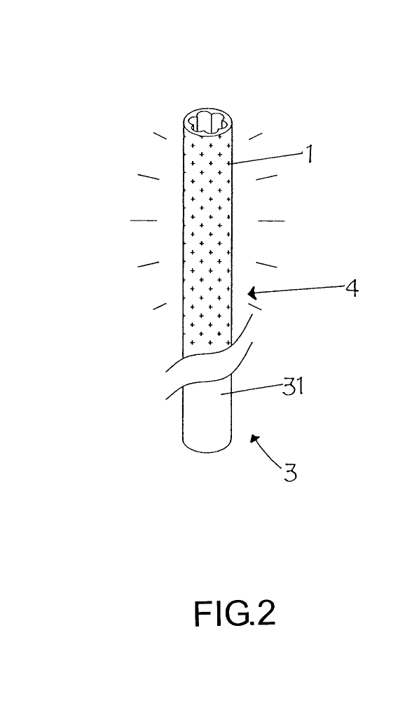

Referring to FIG. 2, the drawing of the first exemplary embodiment of the present invention, the present invention can also spread various fluorescent (1), silvering and phosphorescent agents or pearlescent pigments on the outer rim of a transparent PVC pipe (31) of a molded flexible light (2) to make the color of the spread and molded flexible light (4) colorful, gorgeous and not easy to fade.

According to the abovementioned, a flexible light mixed or spread by various fluorescent agents (1) continues to emit soft tinges due to the absorption of light source energy; in the night, through absorbing the light source energy from the projection of a car light, a street light or other light sources, no matter how far they come from, the fluorescent agents (1) luminesce; even after the light sources disappear, the flexible light with fluorescent agents (1) is still capable of continuing to luminesce for a short while; projected by the lights from passing-by vehicles, the flexible light with fluorescent agents (1) will continue to luminesce and save the electric power; if the flexible light with fluorescent agents (1) luminous, the tinge thereof will be softer and more beautiful; in addition, during the daytime, under the sunshine or reflected by other light sources, the said flexible light with fluorescent agents (1) is still capable of emitting bright and twinkling lights; furthermore, the present invention is luminous in the dark.

According to the abovementioned, the present invention can mix or spread various silvering agents to make a flexible light with silver agents; the said silvering agents are not luminous and need the reflection from external light sources; they are suitable for indicating the road signs; the flexible light with silvering agents are luminous and that increases bright colors, light sources and further enhances the application scope thereof.

According to the abovementioned, the present invention can mix or spread various phosphorescent agents to make a flexible light with phosphorescent agents; the said phosphorescent agents are luminous and suitable for showing the indications in the dark, more especially, at the places where the electric power can't be transmitted easily.

According to the abovementioned, the present invention can mix or spread various pearlescent and colorful pigments to make a flexible light with or pearlescent and colorful pigments; the use of the said pearlescent pigments is based on the structural principle of a natural pearl; it possesses the nature of refraction and antirefraction; its external layer is covered by metal oxide with high index of light refraction and that makes the peripheral mediums with low index of light refraction arrange parallelly to generate visible rainbow luminosity; in addition, it can be added with beautiful silver, gold and copper colors.

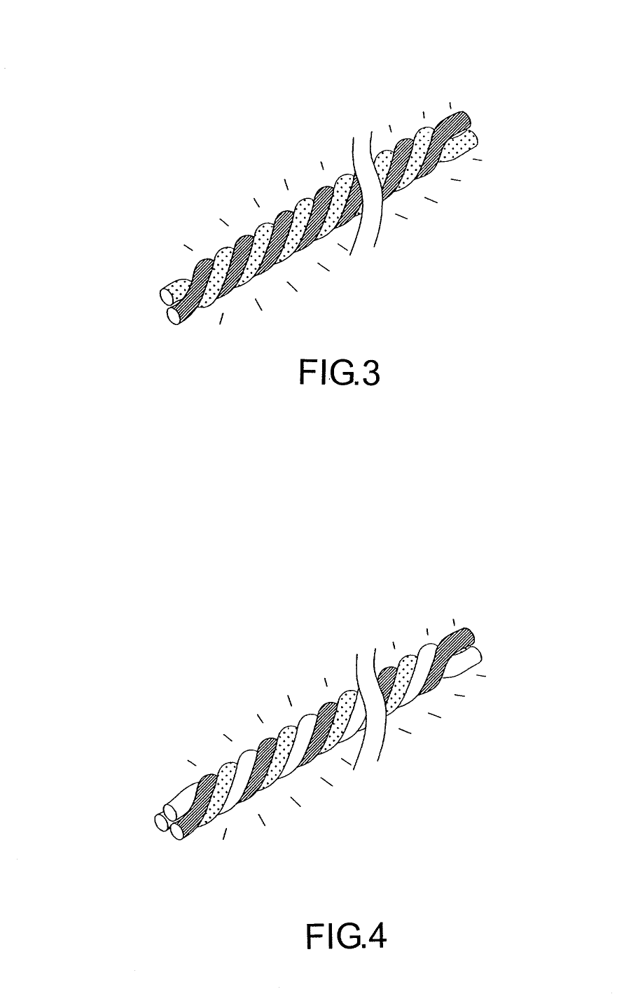

In summation of the abovementioned, the present invention is capable of twisting any two or three strands of flexible lights with fluorescent agents (1), flexible light with silver agents, flexible light with phosphorescent agents or flexible light with pearlescent and colorful pigments together, as shown in FIGS. 3 and 4, to make the present invention more brilliant and gorgeous with strengthened visional effect.

In summation of the abovementioned, the present invention of a tinge structure of a flexible light uses various fluorescent, silvering and phosphorescent agents or pearlescent and colorful pigments to make the color of an entire flexible light unfadable even after a long-term usage; it is incomparable to the monochromatic and traditional flexible light; to the consumers, it possesses economic and practical effects with innovation and advancement.

It is of course to be understood that the embodiment described herein is merely illustrative of the principles of the invention and that a wide variety of modifications thereto may be effected by persons skilled in the art without departing from the spirit and scope of the invention as set forth in the following claims.

1. The present invention of a tinge structure of a flexible light mainly makes the color of the polyvinyl chloride (PVC) pipe of a flexible light colorful, gorgeous and not easy to fade; the features thereof are that various fluorescent, silvering and phosphorescent agents or pearlescent and colorful pigments are respectively mixed into transparent PVC plastic grains to be heated and pressed into a PVC pipe for a molded flexible light.

2. The present invention of a tinge structure of a flexible light mainly makes the color of the polyvinyl chloride (PVC) pipe of a flexible light colorful, gorgeous and not easy to fade; the features thereof are that various fluorescent, silvering and phosphorescent agents or pearlescent and colorful pigments are respectively spread on the outer rim of the PVC pipe of a molded transparent flexible light.
